(19) United States
(12) Patent Application Publication
(10) Pub. No.: US 2026/0280055 A1
(43) Pub. Date: Sep. 17, 2026

(54) SEPARATOR, PREPARATION METHOD THEREOF AND ELECTROCHEMICAL DEVICE INCLUDING THE SAME

(71) Applicant: LG Energy Solution, Ltd, Seoul (KR)

(72) Inventors: Won-Sik BAE, Daejeon (KR); Byeong-Chan Bak, Daejeon (KR); Kyeong-Hui Bai, Daejeon (KR); So-Yeong Lee, Daejeon (KR); In-Young Choi, Daejeon (KR)

(21) Appl. No.: 19/335,779

(22) Filed: Sep. 22, 2025

(30) Foreign Application Priority Data
Oct. 10, 2024 (KR) 10-2024-0138007

(51) Int. Cl. H01M 50/491; H01M 10/04; H01M 50/406; H01M 50/417; H01M 50/46

(52) U.S. Cl. CPC H01M 50/491; H01M 10/0468; H01M 50/406; H01M 50/417; H01M 50/461

(57) ABSTRACT

A separator according to an aspect of the present disclosure includes a polyolefin-based substrate having a thickness of about 8 μm or less. The polyolefin-based substrate has a maximum pore size of about 150 nm or less.

### CROSS-REFERENCE TO RELATED APPLICATIONS

This application is based on and claims priority from Korean Patent Application No. 10-2024-0138007 filed on Oct. 10, 2024, with the Korean Intellectual Property Office, the disclosure of which is incorporated herein in its entirety by reference.

### TECHNICAL FIELD

The present disclosure relates to a separator, a method of manufacturing the separator, an electrode assembly, a method of manufacturing the electrode assembly, and an electrochemical device including the separator and the electrode assembly.

### BACKGROUND

A lithium secondary battery is manufactured through a process of inserting an electrode assembly, which is a unit of a positive electrode/separator/negative electrode, into a battery case, injecting an electrolyte, and sealing the case. The separator functions to prevent or suppress direct physical contact between the positive electrode and the negative electrode. As a separator for use in a lithium secondary battery, for example, a polyolefin-based porous substrate has been used.

Recently, research efforts have been continuously conducted to reduce the weight of battery materials in order to achieve high energy density of lithium secondary batteries. Research has also been conducted to implement a thin-film separator for weight reduction while still using the conventional polyolefin-based porous substrate.

### SUMMARY

The present disclosure provides a separator, and an electrode assembly and an electrochemical device including the separator.

The present disclosure provides a thin-film separator as one of the components of a battery in order to reduce the weight of an electrochemical device, for example, a lithium secondary battery.

The disclosure provides a separator that is thin and yet has excellent insulation properties between a positive electrode and a negative electrode, a method of manufacturing the separator, an electrode assembly to which the separator is applied, and an electrochemical device including the electrode assembly.

According to an aspect of the present disclosure, separators of the following embodiments are provided.

According to a first embodiment, a separator includes a polyolefin-based substrate having a thickness of about 8 μm or less, and the polyolefin-based substrate has a maximum pore size of about 150 nm or less.

According to a second embodiment, in the first embodiment, the maximum pore size may be measured by a method of measuring the pore size when the water saturation degree is about 1 vol % based on 100 vol % of water saturation when water is infiltrated into the polyolefin-based substrate under a constant pressure.

According to a third embodiment, in the first embodiment or the second embodiment, the thickness of the polyolefin-based substrate may be about 5 μm to about 8 μm.

According to a fourth embodiment, in any one of the first to third embodiments, the maximum pore size of the polyolefin-based substrate may be about 120 nm to about 150 nm.

According to a fifth embodiment, in any one of the first to fourth embodiments, the separator may further include at least one of a heat-resistant coating layer and a binder adhesive layer on at least one surface of the polyolefin-based substrate.

According to another aspect of the present disclosure, electrode assemblies of the following embodiments are provided.

According to a sixth embodiment, an electrode assembly includes a separator according to any one of the first to fifth embodiments, and a positive electrode and a negative electrode provided on respective opposite surfaces of the separator.

According to still another aspect of the present disclosure, methods of manufacturing separators of the following embodiments are provided.

According to a seventh embodiment, a method of manufacturing a separator includes the steps of extruding, cooling, and molding a polyolefin resin raw material to obtain a polymer sheet; stretching the obtained polymer sheet in MD and TD; and heat-setting the stretched polymer sheet to obtain a polyolefin-based substrate, in which the heat-setting is performed at a temperature higher than the MD and TD stretching temperatures, and the polyolefin-based substrate has a thickness of about 8 μm or less.

According to an eighth embodiment, in the seventh embodiment, the MD stretching may be performed at a temperature of about 110° C. to about 115° C. at a stretching ratio of about 4 to about 10 times.

According to a ninth embodiment, in the seventh embodiment or the eighth embodiment, the TD stretching may be performed at a temperature of about 125° C. to about 135° C. at a stretching ratio of about 4 to about 10 times.

According to a tenth embodiment, in any one of the seventh to ninth embodiments, the polyolefin-based substrate may have a maximum pore size of about 150 nm or less.

According to still another aspect of the present disclosure, methods of manufacturing electrode assemblies of the following embodiments are provided.

According to an eleventh embodiment, a method of manufacturing an electrode assembly includes the steps of interposing the separator manufactured according to any one of the seventh to tenth embodiments between a positive electrode and a negative electrode, and hot-pressing the obtained laminate of the positive electrode/separator/negative electrode.

According to a twelfth embodiment, in the eleventh embodiment, the hot-pressing may be performed at a temperature of about 55° C. to about 75° C.

According to a thirteenth embodiment, in the eleventh embodiment or the twelfth embodiment, the hot-pressing may be performed at a pressure of about 5 MPa to about 8 MPa.

According to still another aspect of the present disclosure, electrochemical devices of the following embodiments are provided.

According to a fourteenth embodiment, an electrochemical device may include the electrode assembly according to the sixth embodiment and a case accommodating the electrode assembly.

According to a fifteenth embodiment, in the seventh embodiment, the method may further include the step of removing a diluent after the MD stretching and TD stretching steps.

According to a sixteenth embodiment, in the fifteenth embodiment, an amount of the diluent remaining in the polymer sheet formed after extracting the diluent may be about 1 wt % or less based on the total weight of the polymer sheet.

A separator according to an embodiment of the present disclosure may include a polyolefin-based substrate having a thickness of about 8 μm or less.

A separator according to an embodiment of the present disclosure may implement an advantage of being thin while having excellent insulating properties. For example, the separator may exhibit a breakdown voltage (BDV) of about 1,000 V or more.

Furthermore, an electrode assembly to which the separator according to an embodiment of the present disclosure is applied may exhibit excellent voltage resistance properties.

Accordingly, the electrochemical device using the separator may exhibit not only high energy density due to weight reduction, but also excellent insulating properties.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a flowchart illustrating a method of manufacturing a separator according to an embodiment of the present disclosure.

FIG. 2 is a graph illustrating a relationship between pore size and cumulative pore volume of a polyolefin-based substrate according to an embodiment of the present disclosure.

### DETAILED DESCRIPTION

Herein, when a part is referred to as “including” a component, this means that, unless specifically stated otherwise, the part does not exclude other components but may further include other components.

As used herein, the term “A and/or B” means “A or B, or both of them.”

Specific terms used in the following detailed description of the invention are for convenience only and are not intended to limit the present disclosure. For example, words indicating directions such as “upper” and “lower” are terms used illustratively to describe positional relationships with respect to a reference point, and are not intended to limit absolute positional relationships.

As used herein, the terms “about,” “approximately,” and “substantially” are used to mean a range of the numerical value or degree, or a value close thereto, in consideration of inherent manufacturing and material tolerances (e.g., +5%).

As a separator becomes thinner, the inherent function of the separator to block physical contact between a positive electrode and a negative electrode deteriorates, and instead, there is an increased risk of a short-circuit occurring due to contact between the positive electrode and the negative electrode.

Accordingly, it is necessary to improve the safety of the lithium secondary battery by enhancing the performance of the lithium secondary battery while also solving problems such as ignition and thermal runaway of the lithium secondary battery.

In consideration of this, the present disclosure provides a separator that is thin and yet has excellent insulating properties between a positive electrode and a negative electrode, a method of manufacturing the separator, an electrode assembly to which the separator is applied, and an electrochemical device including the electrode assembly.

### Separator

According to an aspect of the present disclosure, a separator including a polyolefin-based substrate is provided.

For example, a separator according to an aspect of the present disclosure includes a polyolefin-based substrate having a thickness of about 8 μm or less.

In addition, a separator according to an aspect of the present disclosure includes a polyolefin-based substrate having a maximum pore size of about 150 nm or less.

Alternatively, a separator according to an aspect of the present disclosure includes a polyolefin-based substrate having a thickness of about 8 μm or less, and the polyolefin-based substrate has a maximum pore size of about 150 nm or less.

The polyolefin-based substrate used as a separator substrate includes a plurality of pores on a surface and/or in the inside thereof. Through the plurality of pores, even when the separator is interposed between a positive electrode and a negative electrode, charge transfer and lithium-ion transport between the positive electrode and the negative electrode are possible. However, when the thickness of the polyolefin-based substrate is reduced, for example, 8 μm or less, when the pore size increases, pores formed on one surface of the polyolefin-based substrate and pores formed on the other surface may communicate with each other, which may cause a short-circuit between the positive electrode and the negative electrode.

In order to prevent or suppress such a problem, a separator substrate according to an aspect of the present disclosure has a maximum pore size of about 150 nm or less.

As used herein, the “maximum pore size” refers to a value measured by a water intrusion method. For example, when water is infiltrated into the polyolefin-based separator substrate under a constant pressure, a graph of cumulative pore volume (vol %) according to pore size (nm) may be obtained. At this time, when a point where the pore volume is 100 vol % is defined as a state in which the water saturation degree is 100 vol %, and a point where the pore volume is 1 vol % is defined as a state in which the water saturation degree is 1 vol %, the maximum pore size refers to a pore size (nm) value at the time when the water saturation degree is 1 vol % based on 100 vol % of water saturation.

According to an embodiment of the present disclosure, when performing the water intrusion method, water may be injected in a pressure range of, for example, about 150 psi to about 1,800 psi, but the present disclosure is not limited thereto.

According to an embodiment of the present disclosure, the maximum pore size of the polyolefin-based substrate may be about 150 nm or less, for example, about 100 nm to about 150 nm, about 110 nm to about 150 nm, about 120 nm to about 150 nm, about 130 nm to about 150 nm, about 135 nm to about 145 nm, about 140 nm to about 145 nm, about 135 nm to about 140 nm, or 140 nm or 145 nm, but the present disclosure is not limited thereto. When the maximum pore size of the polyolefin-based substrate is within the above-described range, advantageous effects in terms of air permeability and insulation property of the separator may be exhibited, but the present disclosure is not limited thereto.

According to an embodiment of the present disclosure, the thickness of the polyolefin-based substrate is not particularly limited as long as it is about 8 μm or less. According to an embodiment, in terms of mechanical strength of the separator, for example, the thickness may be about 3 μm to about 8 μm, about 4 μm to about 8 μm, about 5 μm to about 8 μm, about 6 μm to about 7 μm, about 6.5 μm to about 7.5 μm, or about 7.0 μm, but the present disclosure is not limited thereto.

As used herein, the “thickness” of the polyolefin-based substrate may be measured by a known method of measuring each thickness of components of an electrochemical device. For example, the thickness of the polyolefin-based substrate may be measured using a known thickness gauge, and may be measured using, for example, a commercially available thickness gauge (Mitutoyo Co., VL-50S-B, tip diameter: 9.5 mm, spherical radius: 10 mm).

In an embodiment of the present disclosure, the polyolefin-based substrate may be manufactured by using a polyolefin-based material as a thermoplastic resin in order to perform an ion-conductive barrier function of blocking contact between a positive electrode and a negative electrode while allowing ions to pass therethrough for the inherent function of the separator, and also to perform a shutdown function.

In an embodiment of the present disclosure, the polyolefin-based substrate refers to a substrate including a material formed through polymerization of olefin, and is not particularly limited as long as it is used as a separator. For example, the olefin may include polyethylene, polypropylene, or a mixture thereof.

According to an embodiment of the present disclosure, the separator may include a polyolefin-based substrate manufactured by a wet process as described below. The polyolefin-based substrate may be manufactured by either a wet process or a dry process. In this case, the polyolefin-based substrate may be manufactured by the wet process in terms of implementing the polyolefin-based substrate in a thin-film form and increasing the uniformity of pore size.

According to an embodiment of the present disclosure, the separator may further include a binder adhesive layer including a binder polymer on at least one surface of the polyolefin-based substrate to improve adhesion to an electrode.

In another embodiment of the present disclosure, the separator may further include a heat-resistant coating layer formed on at least one surface of the polyolefin-based substrate and including inorganic particles and a binder polymer to enhance heat resistance.

In still another embodiment of the present disclosure, the separator may further include a heat-resistant coating layer and/or a binder adhesive layer on at least one surface of the polyolefin-based substrate, but the present disclosure is not limited thereto.

In an embodiment of the present disclosure, the binder polymer that may be used in the binder adhesive layer and/or the heat-resistant coating layer is not particularly limited as long as it is a material that can be used in a separator to exhibit adhesion. For example, the binder polymer may include a polyvinylidene fluoride (PVdF)-based resin, an acrylic resin, a rubber-based resin, or a mixture of two or more thereof, but the present disclosure is not limited thereto.

In an embodiment of the present disclosure, the inorganic particles that may be used in the heat-resistant coating layer are not particularly limited as long as they are electrochemically stable. For example, the inorganic particles are not particularly limited as long as they do not undergo oxidation and/or reduction reactions within the operating voltage range (e.g., 0 to 5 V based on Li/Li⁺) of an electrochemical device to which the separator is applied. For example, the inorganic particles may include BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, NiO, CaO, ZnO, ZrO₂, SiO₂, Y₂O₃, Al₂O₃, SiC, and TiO₂, and may include one or more thereof, but the present disclosure is not limited thereto.

In an embodiment of the present disclosure, when the separator further includes the heat-resistant coating layer, in order to prevent pores of the separator from being blocked by the inorganic particles and thereby preventing a decrease in porosity of the separator, the average particle diameter (D50) of the inorganic particles may be about 100 nm or more. For example, the average particle diameter (D50) of the inorganic particles may be about 100 nm to about 1 μm, or about 100 nm to about 500 nm, but the present disclosure is not limited thereto.

Herein, the particle diameter of the inorganic particles may be measured by a known particle size measuring method, and may be measured using, for example, a particle size analyzer (PSA) commercially available from Malvern Panaylitical Ltd. In addition, the average particle diameter (D50) refers to a particle diameter at a 50% point of a cumulative volume distribution according to particle diameter, and may be measured by a known laser diffraction method. In this case, the laser diffraction particle size measuring apparatus may be, for example, a Microtrac S3500 commercially available from Microtrac Inc.

In an embodiment of the present disclosure, the thickness of the binder adhesive layer and/or the heat-resistant coating layer is not particularly limited as long as it does not impair the objective of the present disclosure of thinning the separator. For example, the thickness of the binder adhesive layer and/or the heat-resistant coating layer may be about 0.5 μm to about 20 μm, about 0.5 μm to about 10 μm, about 0.5 μm to about 5 μm, or about 1.5 μm to about 3 μm, but the present disclosure is not limited thereto.

A separator according to an embodiment of the present disclosure may inherently have insulating properties by including a polyolefin-based substrate. As described above, when the thickness of the polyolefin-based substrate is small, there may arise a problem in which the insulating properties deteriorate unless the maximum pore size is restricted. However, the separator according to an embodiment of the present disclosure may have an advantage of excellent insulating properties by implementing the polyolefin-based substrate to be thin while restricting the maximum pore size.

A separator according to an embodiment of the present disclosure may have a thickness of about 8 μm or less and may exhibit a breakdown voltage of about 1,000 V or more.

A separator according to an embodiment of the present disclosure may exhibit, for example, a breakdown strength of about 120 V/μm or more. For example, the separator may exhibit a breakdown strength of about 120 V/μm to about 200 V/μm, about 130 V/μm to about 180 V/μm, about 140 V/μm to about 160 V/μm, about 140 V/μm to about 155 V/μm, about 140 V/μm to about 150 V/μm, or about 143 V/μm to about 150 V/μm, but the present disclosure is not limited thereto.

As used herein, the “breakdown voltage” and “breakdown strength” of the separator may be measured by a known method of measuring the breakdown voltage and breakdown strength of an insulating material, and are not particularly limited by the measuring method.

According to an embodiment of the present disclosure, the breakdown voltage and the breakdown strength may be measured according to the method of Standard No. KS C IEC60243-2. For example, a separator sample to be measured may be placed between an upper jig and a lower jig made of aluminum (e.g., an upper jig having a diameter of 30 mm and a lower jig having a diameter of 50 mm), and when the voltage applied to the sample is stepwise increased, a voltage at which current flows through the sample may be measured to obtain a breakdown voltage (V) value, and the measured breakdown voltage value may be divided by the thickness (d) of the separator sample to obtain a breakdown strength (V/d) value. At this time, the measuring device for measuring the breakdown voltage is not limited as long as it is a device capable of measuring the breakdown voltage according to the above-described standard method. For example, an AC/DC/IR Hi-pot tester (Chroma Co., Model 19052) may be used as the measuring device, but the present disclosure is not limited thereto.

### Electrode Assembly

According to another aspect of the present disclosure, an electrode assembly including the above-described separator and a positive electrode and a negative electrode that are formed on respective opposite surfaces of the separator is provided.

As described above, a separator according to an aspect of the present disclosure has improved insulating properties to implement a high breakdown voltage and breakdown strength. Therefore, when manufacturing an electrode assembly using the separator, the effect of significantly improving a short-circuit failure rate between the positive electrode and the negative electrode may be achieved due to the high insulating properties of the separator.

Hereinafter, the configuration of the electrode will be described by way of example. However, the present disclosure is not limited thereto.

In an embodiment of the present disclosure, the positive electrode and the negative electrode may each be formed by coating an electrode active material on a current collector, and the size, shape, and type of the active material are not particularly limited.

In an embodiment of the present disclosure, a positive electrode and a negative electrode may be used to verify the short-circuit failure rate of an electrode assembly using the separator, and the types of the electrodes are not particularly limited.

For example, the electrode assembly may include, as a positive electrode active material: lithium transition metal oxides; lithium metal iron phosphates; lithium nickel-manganese-cobalt oxides; lithium nickel-manganese-cobalt oxides in which a portion is substituted with another transition metal; or two or more thereof, but is not limited thereto. For example, the positive electrode active material may include: a layered compound such as lithium cobalt oxide (LiCoO₂), lithium nickel oxide (LiNiO₂), or a compound substituted with one or more transition metals; a lithium manganese oxide such as Li₁₊ₓMn₂₋ₓO₄ (where x=0 to 0.33), LiMnO₃, LiMn₂O₃, or LiMnO₂; lithium copper oxide (Li₂CuO₂); a vanadium oxide such as LiV₃O₈, LiV₃O₄, V₂O₅, or Cu₂V₂O₇; a Ni-site lithium nickel oxide represented by the chemical formula LiNi₁₋ₓMₓO₂ (where M=Co, Mn, Al, Cu, Fe, Mg, B, or Ga, and x=0.01 to 0.3); a lithium manganese composite oxide represented by the chemical formula LiMn₂₋ₓMₓO₂ (where M=Co, Ni, Fe, Cr, Zn, or Ta, and x=0.01 to 0.1) or Li₂Mn₃MO₈ (where M=Fe, Co, Ni, Cu, or Zn); a lithium metal phosphate represented by the chemical formula LiMPO₄ (where M=Fe, Co, Ni, or Mn); a lithium nickel-manganese-cobalt oxide represented by the chemical formula Li₁₊ₓ(NiₐCo_{b}Mn_{c})₁₋ₓO₂ (x=0 to 0.03, a=0.3 to 0.95, b=0.01 to 0.35, c=0.01 to 0.5, and a+b+c=1); a lithium nickel-manganese-cobalt oxide partially substituted with aluminum and represented by the chemical formula Liₐ[Ni_{b}Co_{c}Mn_{d}Alₑ]_{1-f}M1_{f}O₂ (M1 is at least one selected from Zr, B, W, Mg, Ce, Hf, Ta, La, Ti, Sr, Ba, F, P, and S, 0.8≤a≤1.2, 0.5≤b≤0.99, 0<c<0.5, 0<d<0.5, 0.01≤e≤0.1, and 0≤f≤0.1); a lithium nickel-manganese-cobalt oxide partially substituted with another transition metal and represented by the chemical formula Li₁₊ₓ(NiₐCo_{b}Mn_{c}M_{d})₁₋ₓO₂ (x=0 to 0.03, a=0.3 to 0.95, b=0.01 to 0.35, c=0.01 to 0.5, d=0.001 to 0.03, a+b+c+d=1, and M is one selected from Fe, V, Cr, Ti, W, Ta, Mg, and Mo); a disulfide compound; or Fe₂(MoO₄)₃, but is not limited thereto.

In an embodiment of the present disclosure, the electrode assembly may include, as a negative electrode active material: carbon such as non-graphitizable carbon or graphitic carbon; a metal composite oxide such as LiₓFe₂O₃ (0≤x≤1), LiₓWO₂ (0≤x≤1), or SnₓMe₁₋ₓMe′_{y}O_{z} (where Me is Mn, Fe, Pb, or Ge; Me′ is Al, B, P, Si, a Group 1, 2, or 3 element of the periodic table, or a halogen; 0<x≤1; 1≤y≤3; 1≤z≤8); lithium metal; a lithium alloy; a silicon-based alloy; a tin-based alloy; a silicon-based oxide such as SiO, SiO/C, or SiO₂; a metal oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, or Bi₂O₅; a conductive polymer such as polyacetylene; or a Li—Co—Ni-based material, but is not limited thereto.

In an embodiment of the present disclosure, the positive electrode may be prepared, for example, by the following method. First, a positive electrode active material (LiNi_{0.8}Mn_{0.1}Co_{0.1}O₂), a conductive material (carbon black), a dispersant, and a binder resin (PVDF) are mixed with water in a weight ratio of about 97.5:0.7:0.2:1.6 to prepare a positive electrode active material layer slurry with a concentration of 50 wt % of the components other than water. Next, the slurry is applied to the surface of an aluminum thin film (e.g., with a thickness of 10 μm) and dried to manufacture a positive electrode having a positive electrode active material layer (e.g., with a thickness of 60 μm). The above-described method of manufacturing a positive electrode is merely an example and is not intended to limit the present disclosure.

In an embodiment of the present disclosure, the negative electrode may be prepared, by way of example, as follows. First, artificial graphite, carbon black, carboxymethyl cellulose (CMC), and a binder resin (SBR) is mixed with water in a weight ratio of about 97.5:0.7:1.1:0.7 to prepare a negative electrode active material layer slurry with a concentration of about 50 wt % of the components other than water. Next, the slurry is applied to the surface of a copper thin film (e.g., with a thickness of 10 μm) and dried to manufacture a negative electrode having a negative electrode active material layer (e.g., with a thickness of 60 μm). The above-described method of manufacturing a negative electrode is merely an example and is not intended to limit the present disclosure.

According to an embodiment of the present disclosure, the electrode assembly may include a structure of a negative electrode/a separator/a positive electrode sequentially stacked, and the insulating properties of the electrode assembly may be tested using a known Hi-pot tester to measure a failure rate thereof. For example, after preparing at least 20 samples of the electrode assembly, a failure rate may be measured by checking whether dielectric breakdown occurs when current is applied under conditions of 50 V and <0.5 mA (charge time: 50 ms, test time: 50 ms) using a Hi-pot tester (Chroma Co., Model 19052).

According to an embodiment of the present disclosure, when measuring a failure rate of the electrode assembly by the above-described method, the electrode assembly using the separator may implement an effect of exhibiting a failure rate of 0% among 20 samples.

According to another embodiment of the present disclosure, when measuring a failure rate of the electrode assembly by the above-described method, the electrode assembly may implement an effect of exhibiting a failure rate of 1% or less, or 0.5% or less, even when the number of samples (n) of the electrode assembly is increased to 100 or more, but the present disclosure is not limited thereto.

### Method of Manufacturing Separator and Electrode Assembly

Hereinafter, a method of manufacturing a separator according to an aspect of the present disclosure will be described. However, the following manufacturing method is merely illustrative of the method of manufacturing the separator, and the method of manufacturing the separator is not limited thereto.

According to another aspect of the present disclosure, a method of manufacturing the separator is provided.

The method of manufacturing the separator according to another aspect of the present disclosure may adopt a wet process.

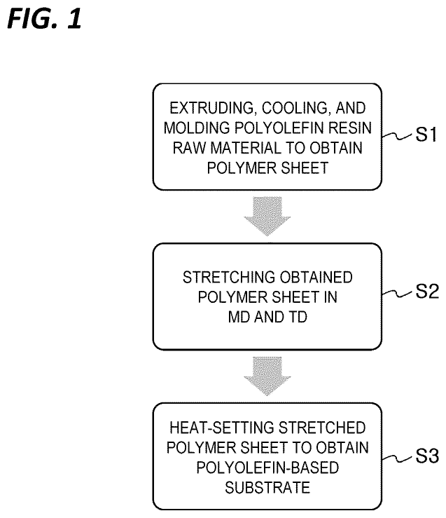

Referring to FIG. 1, the method of manufacturing the separator may include the steps of: (S1) extruding, cooling, and molding a polyolefin resin raw material to obtain a polymer sheet; (S2) stretching the obtained polymer sheet in MD and TD; and (S3) heat-setting the stretched polymer sheet to obtain a polyolefin-based substrate.

A method of manufacturing a separator according to an aspect of the present disclosure may manufacture the polyolefin-based substrate to have a thickness of about 8 μm or less.

In addition, the method of manufacturing a separator according to an aspect of the present disclosure may manufacture the polyolefin-based substrate to have a maximum pore size of about 150 nm or less.

According to an embodiment of the present disclosure, the polyolefin-based substrate is formed by using a polyolefin resin as a raw material and processing the polyolefin resin into a polymer sheet through a series of high-temperature extrusion, cooling, and stretching processes. At this time, the polymer sheet has a characteristic in which the properties of pores formed on its surface vary depending on the temperature and pressure applied during the manufacturing process. In order to manufacture a porous polymer substrate that is produced without damage to the polymer sheet during the above series of processes, a polyethylene resin may be included as the polyolefin resin. However, any polyolefin-based resin other than the polyethylene resin may be used without limitation.

In an embodiment of the present disclosure, the polyolefin resin may include, for example, one having a weight-average molecular weight (Mw) of about 500,000 g/mol to about 5,000,000 g/mol. For example, the weight-average molecular weight of the polyolefin resin may be about 500,000 g/mol to about 2,000,000 g/mol, about 500,000 g/mol to about 1,000,000 g/mol, about 500,000 g/mol to about 800,000 g/mol, about 500,000 g/mol to about 700,000 g/mol, or about 550,000 g/mol to about 650,000 g/mol. Alternatively, the weight-average molecular weight of the polyolefin resin may be, for example, about 600,000 g/mol, but the present disclosure is not limited thereto.

At this time, the weight-average molecular weight of the polymer may represent a value measured according to a measurement method of an embodiment, and may represent a value measured using, for example, a gel permeation chromatograph (GPC). In this case, the GPC measurement conditions may be referred to the following conditions, but the present disclosure is not limited thereto.
Column: PL Olexis (Polymer Laboratories Co.)
Solvent: trichlorobenzene (TCB)
Flow rate: 1.0 ml/min
Sample concentration: 1.0 mg/ml
Injection volume: 200 μl
Column temperature: 160° C.
Detector: Agilent High Temperature RI detector
Standard: Polystyrene (calibrated by a cubic function)

The step (S1) is a step of extruding a raw material including the above-described polyolefin resin to obtain an extrudate, and cooling and molding the high-temperature extrudate to obtain a polymer sheet.

In an embodiment of the present disclosure, the extrusion may be performed by a process for extruding a polymer in the field of separator manufacturing. For example, as the extruder for the extrusion, a single-screw extruder or a twin-screw extruder may be used, but the present disclosure is not limited thereto.

In an embodiment of the present disclosure, the extrusion may be performed by introducing a polyolefin resin and a diluent into an extruder and melt-extruding the mixture at a temperature of, for example, about 170° C. to about 250° C., for example, at about 200° C.

In an embodiment of the present disclosure, the diluent may be used by using a diluent used in a separator manufacturing process for diluting raw materials. The diluent refers to a substance that is mixed with a polyolefin-based resin to form an extrudate, undergoes phase separation upon cooling, and is removed to form pores. The diluent is not particularly limited as long as it satisfies such a function. Non-limiting examples of such a diluent include: aliphatic hydrocarbon-based solvents such as paraffin oil; vegetable oils such as soybean oil; or plasticizers such as dialkyl phthalates, but the present disclosure is not limited thereto. Among these, liquid paraffin oil, which has excellent compatibility with polyolefin-based resins, for example, paraffin oil having a kinematic viscosity of 20 to 200 cSt at 40° C., may be suitably used. The diluent may be used alone or in the form of a mixture of two or more kinds.

In an embodiment of the present disclosure, the extruded melt may be discharged through a die, and at this time, the thickness of the polyolefin-based substrate to be manufactured may be controlled by adjusting the discharged amount.

In an embodiment of the present disclosure, the manufactured polyolefin-based substrate may be discharged so as to implement a thickness of about 8 μm or less.

Next, after obtaining the extrudate, the extrudate may be cooled to obtain a polymer pre-sheet.

According to an embodiment of the present disclosure, the obtained extrudate may be molded into a sheet form using a cooling casting device at a temperature of about 20° C. to about 60° C. For example, the extrudate discharged from the extrusion unit may be cooled and molded into a polymer sheet form by passing between a pair of cooling casting rolls at a running speed of 7 m/min at a temperature of 40° C.

The step (S2) is a step of stretching the obtained polymer sheet in a machine direction (MD) and a transverse direction (TD) perpendicular thereto, respectively.

In an embodiment of the present disclosure, the step (S2) may include a process of sequentially stretching the polymer pre-sheet in the machine direction and the transverse direction, and may include, for example, a process of stretching the sheet about 3 to about 9 times in the machine direction and about 3 to about 9 times in the transverse direction using a tenter-type stretcher.

In an embodiment of the present disclosure, a pore size formed in the polymer sheet may vary depending on the stretching ratios and/or temperatures in the MD and TD stretching. Therefore, to ensure that the maximum pore size of the obtained polyolefin-based substrate is implemented to be about 150 nm or less, the MD and TD stretching ratios and/or temperatures may be controlled as follows.

In an embodiment of the present disclosure, the MD stretching may be performed at a temperature of about 125° C. or less, for example, about 100° C. to about 125° C., about 100° C. to about 120° C., about 110° C. to about 115° C., or about 110° C. to about 112° C., in consideration of the melting temperature of the polyolefin-based resin. When the MD stretching temperature becomes too high, the maximum pore diameter of the obtained polyolefin-based substrate may become too small due to proximity to the melting point of the polyolefin resin, and thus a problem may arise in which the intrinsic porosity of the separator may not be secured.

In an embodiment of the present disclosure, the MD stretching may be performed at a stretching ratio of about 6 to about 9 times, 6 to 8 times, 6 to 7 times, about 6.0 to about 6.5 times, about 6.0 to about 6.3 times, or about 6.0 to about 6.1 times, but the present disclosure is not limited thereto.

In an embodiment of the present disclosure, the MD stretching may be performed at a temperature of about 110° C. to about 115° C. at a stretching ratio of about 6.0 to about 6.5 times, but the present disclosure is not limited thereto.

In an embodiment of the present disclosure, the TD stretching may be sequentially performed after the MD stretching. At this time, as the degree of crystallinity of the polymer sheet increases through the MD stretching, the TD stretching may be performed at a temperature within a predetermined range higher than the MD stretching. For example, the TD stretching may be performed at a temperature higher than the MD stretching temperature by about 5° C. or more, about 10° C. or more, about 15° C. or more, about 20° C. or more, or about 5° C. to about 20° C., about 10° C. to about 20° C., or about 15° C. to about 20° C. For example, the TD stretching may be performed at a temperature of about 125° C. or more, for example, about 125° C. to about 140° C., about 125° C. to about 135° C., about 130° C. to about 135° C., about 130° C. to about 132° C., or about 130° C. to about 131.5° C., but the present disclosure is not limited thereto.

In an embodiment of the present disclosure, the TD stretching may be performed at a stretching ratio of about 6 to about 9 times, about 7 to 9 times, about 7 to 8 times, about 7.5 to 8 times, or about 7.5 to about 8.0 times, but the present disclosure is not limited thereto.

In an embodiment of the present disclosure, the TD stretching may be performed at a temperature of about 125° C. to about 135° C. at a stretching ratio of about 7.5 to about 8.0 times, but the present disclosure is not limited thereto.

In an embodiment of the present disclosure, after the MD stretching and the TD stretching of the polymer sheet, a process of removing the diluent used in the preceding process may be further performed.

In an embodiment of the present disclosure, a process of extracting and removing the diluent may be performed using an appropriate solvent for the removal of the diluent. The solvent usable for removing the diluent is not particularly limited, and any solvent capable of extracting the diluent used in the extrusion step may be used. For example, methyl ethyl ketone, methylene chloride, or hexane, which exhibits high extraction efficiency and fast drying, may be used. Methylene chloride may be used as an example. As the extraction method, any solvent extraction method, such as an immersion method, a solvent spray method, or an ultrasonic method, may be used individually or in combination.

In an embodiment of the present disclosure, the amount of the diluent remaining in the polymer sheet after the extraction of the diluent may be about 1 wt % or less, based on the total weight of the polymer sheet. When the residual diluent exceeds about 1 wt %, there may be a problem in that the physical properties deteriorate and the permeability of the membrane decreases, but the present disclosure is not limited thereto.

The step (S3) serves to reduce thermal shrinkage properties by holding the polymer sheet in which pores are formed through removal of the diluent in the MD and/or the TD and applying heat, and may be performed according to a method of an embodiment.

In an embodiment of the present disclosure, the manufacturing method performs the heat-setting at a higher temperature than the MD stretching temperature and the TD stretching temperature in order to implement the maximum pore size of the obtained polyolefin-based substrate to be about 150 nm or less.

For example, the heat-setting may be performed at a temperature higher than the MD stretching temperature by about 5° C. or more, 10° C. or more, 15° C. or more, 20° C. or more, or about 5° C. to about 25° C., about 10° C. to about 25° C., about 15° C. to about 25° C., or about 15° C. to about 20° C. In addition, the heat-setting may be performed at a temperature higher than the TD stretching temperature by at least about 0.5° C. or more or 1° C. or more, for example, about 0.5° C. to about 5° C., about 0.5° C. to about 3° C., about 1.0° C. to about 3.0° C., about 0.5° C. to about 2.0° C., about 0.5° C. to about 1.5° C., or about 0.5° C. to about 1.0° C.

In an embodiment of the present disclosure, the heat-setting may be performed at a temperature of about 125° C. or more, or about 125° C. to about 140° C., about 130° C. to about 140° C., about 130° C. to about 135° C., about 130° C. to about 132° C., or about 131° C. to about 132° C., but the present disclosure is not limited thereto.

In an embodiment of the present disclosure, the heat-setting may be performed by holding the polymer sheet in the MD and/or the TD and applying heat. In this case, the stretching ratio in the MD and/or the TD may be about 1.0 to about 1.5 times, for example, about 1.0 to about 1.3 times, about 1.1 to about 1.2 times, or about 1.0 to about 1.1 times, but the present disclosure is not limited thereto.

In this way, according to an embodiment of the present disclosure, the polyolefin-based substrate obtained as described above may include only pores, which are empty spaces between polyolefin fibers and polyolefin. Thus, according to an aspect of the present disclosure, a polyolefin-based substrate having a thickness of about 8 μm or less and a maximum pore size of about 150 nm or less may be obtained.

In an embodiment of the present disclosure, the polyolefin-based substrate obtained as described above itself may be used as a separator.

In another embodiment of the present disclosure, by further performing the step of forming a binder adhesive layer and/or a heat-resistant coating layer on at least one surface of the polyolefin-based substrate obtained as described above, a separator provided with a binder adhesive layer and/or a heat-resistant coating layer on at least one surface of the polyolefin-based substrate may be obtained.

According to another aspect of the present disclosure, a method of manufacturing an electrode assembly using the separator obtained as described above is provided.

In a method of manufacturing the electrode assembly, the method may include the steps of interposing the separator manufactured as described above between a positive electrode and a negative electrode; and laminating the obtained positive electrode/separator/negative electrode laminate.

According to an embodiment of the present disclosure, the laminating step may use a hot-press process.

For example, the hot-press may be performed to bond the positive electrode/separator/negative electrode laminate by applying temperature and pressure to the laminate using a hot-press machine.

In an embodiment of the present disclosure, the hot-press may be performed, for example, at a temperature of about 55° C. to about 75° C., about 55° C. to about 70° C., about 60° C. to about 65° C., or about 60° C., but the present disclosure is not limited thereto.

In an embodiment of the present disclosure, the hot-press may be performed, for example, at a pressure of about 5 MPa to about 8 MPa, about 5 MPa to about 7 MPa, about 6 MPa to about 6.5 MPa, or about 6.0 MPa to about 6.5 MPa, but the present disclosure is not limited thereto.

In an embodiment of the present disclosure, the hot-press may be performed under conditions of 60° C. and 6.5 MPa, but the present disclosure is not limited thereto.

### Electrochemical Device

According to another aspect of the present disclosure, an electrochemical device in which the above-described electrode assembly is accommodated in a case may be provided.

In an embodiment of the present disclosure, the electrochemical device may be, for example, a primary battery, a secondary battery, a super capacitor, or an electric double layer capacitor. The secondary battery may be a lithium-ion secondary battery.

In an embodiment of the present disclosure, the case is a battery case, and the external shape of the case is not particularly limited depending on the use of the battery. For example, the case may be cylindrical, prismatic, pouch-type, or coin-type using a can.

When the electrode assembly as described above is completed, it may be accommodated in the case and sealed to manufacture an electrochemical device. In this case, the electrochemical device may be, for example, a lithium secondary battery. In an embodiment of the present disclosure, the electrochemical device may further include, for example, an electrolyte and an insulating film, when necessary. Since conventional ones may be used, a detailed description thereof will be omitted.

Hereinafter, the present disclosure will be described in more detail through examples, but the following examples are merely provided to illustrate the present disclosure, and the scope of the present disclosure is not limited thereto.

### [Manufacture of Polyolefin Substrate]

### Example 1

Into an extruder (Korea EM, φ32 twin-screw extruder, L/D=56) were fed 9 kg of high-density polyethylene (HDPE) (Daehan Petrochemical, VH035) and 21 kg of a diluent (Kukdong Petrochemical, LP350F), and followed by melt-extrusion at 200° C. to obtain a polyethylene melt extrudate. The obtained melt extrudate was passed through a T-die, and then cooled and molded into a sheet form using a cooling casting device at a running speed of 7 m/min at a temperature of 40° C. Subsequently, the extrudate was subjected to MD stretching (112° C., stretching ratio 6.0) followed by TD stretching (130° C., stretching ratio 8.0) using a tenter-type sequential stretcher. From the stretched polyolefin, a porous film was formed by extracting the diluent using methylene chloride, and then heat-set at a temperature of 132° C. (stretching ratio 1.2) to obtain a polyolefin substrate having a thickness of 7 μm.

### Example 2

A polyolefin substrate having a thickness of 7 μm was obtained in the same manner as in Example 1, except that the MD stretching ratio was changed to 6.1 times and the TD stretching was performed at 131.5° C.

### Comparative Example 1

A polyolefin substrate having a thickness of 7 μm was obtained in the same manner as in Example 1, except that the MD stretching ratio was changed to 6.3 times, the TD stretching was performed under conditions of 133.5° C. and a stretching ratio of 8.4 times, and the heat-setting was performed under conditions of 131° C. and a stretching ratio of 1.3 times.

### [Evaluation of Physical Properties of Polyolefin Substrate]

### Measurement of Maximum Pore Size (nm)

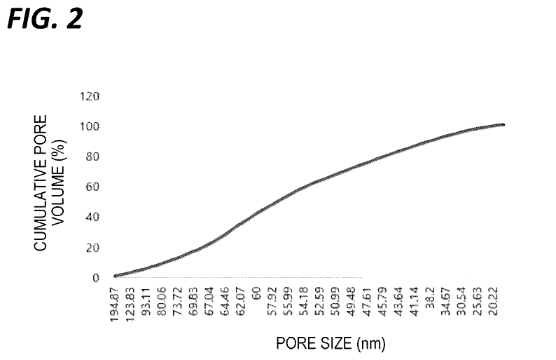

Referring to FIG. 2, the maximum pore size of the polyolefin substrate manufactured as described above was measured using an Aqua Pore instrument (WMI-5K, Poretech Instrument Co.) using the water intrusion method. Water was infiltrated into the polyolefin substrate under a pressure of 150 psi to 1,800 psi until the pores of the polyolefin substrate reached a saturated state (100 vol %), and a graph of cumulative pore volume as a function of pore size (nm) was obtained. In the graph, the pore size (nm) at which water initially infiltrated at 1 vol % was measured as the maximum pore size.

### Measurement of Breakdown Voltage (V)

The measurement was carried out using an AC/DC/IR Hi-pot tester (Chroma Co., Model 19052). A prepared separator sample was placed between an upper aluminum jig (diameter: 30 mm) and a lower aluminum jig (diameter: 50 mm), and the voltage at which a fail condition (>0.5 mA for 3 seconds) occurred was measured using a Hi-pot tester.

At this time, the measurement conditions were set to DC, current 0.5 mA, and voltage ramping 100 V/s (up to 3 kV). The measured value was represented as the average value of 30 samples.

### Measurement of Breakdown Strength (V/d)

The measured breakdown voltage was divided by the thickness (d) of the separator sample to calculate the breakdown strength (V/μm).

### Measurement of Hi-Pot Failure Rate

Using the polyolefin substrate manufactured as described above as a separator, 20 electrode assemblies were prepared as described below, and a Hi-pot test was performed. The Hi-pot test was carried out using a Hi-pot tester (Chroma Co., Model 19052) under conditions of 50 V and <0.5 mA (charge time: 50 ms, test time: 50 ms) to measure whether a failure occurred.

Each electrode assembly was prepared as follows.

### 1) Manufacture of Positive Electrode

A positive electrode active material (LiNi_{0.8}Mn_{0.1}Co_{0.1}O₂), a conductive material (carbon black), a dispersant, and a binder resin (PVDF) were mixed with water in a weight ratio of 97.5:0.7:0.2:1.6 to prepare a positive electrode active material layer slurry with a concentration of 50 wt % of the components other than water. Next, the slurry was applied to the surface of an aluminum thin film (thickness: 10 μm) and dried to manufacture a positive electrode having a positive electrode active material layer (thickness: 60 μm).

### 2) Manufacture of Negative Electrode

Artificial graphite, carbon black, carboxymethyl cellulose (CMC), and a binder resin (SBR) were mixed with water in a weight ratio of 97.5:0.7:1.1:0.7 to prepare a negative electrode active material layer slurry with a concentration of 50 wt % of the components other than water. Next, the slurry was applied to the surface of a copper thin film (thickness: 10 μm) and dried to manufacture a negative electrode having a negative electrode active material layer (thickness: 60 μm).

### 3) Lamination Process

A separator was interposed between the manufactured negative electrode and positive electrode, and a lamination process was performed under conditions of 60° C. and 6.5 MPa for 10 seconds using a hot press to obtain an electrode assembly.

TABLE 1

| | | Breakdown | Breakdown | Hi-pot |
|---|---|---|---|---|
| | Maximum pore | voltage | strength | failure rate |
| | size (nm) | (V) | (V/μm) | (n/20) |
| Example 1 | 140 | 1,050 | 150 | 0 |
| Example 2 | 145 | 1,000 | 143 | 0 |
| Comparative | 155 | 830 | 119 | 7 |
| Example 1 | | | | |

As indicated in the results of Table 1, when the maximum pore size exceeded 150 nm, a rapid decrease in breakdown voltage occurred, and it was confirmed that the short-circuit failure rate during battery manufacturing increased by 35%. For example, in Examples 1 and 2, no electrode assemblies were determined to be defective when measuring the Hi-pot failure rate, whereas in Comparative Example 1, 7 out of 20 electrode assemblies were determined to be defective.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A separator comprising:
a polyolefin-based substrate having a thickness of about 8 μm or less,
wherein the polyolefin-based substrate has a maximum pore size of about 150 nm or less.

2. The separator according to claim 1, wherein the maximum pore size is measured by a method of measuring the pore size when the water saturation degree is about 1 vol % based on 100 vol % of water saturation when water is infiltrated into the polyolefin-based substrate under a constant pressure.

3. The separator according to claim 1, wherein the thickness of the polyolefin-based substrate is about 5 μm to about 8 μm.

4. The separator according to claim 1, wherein the maximum pore size of the polyolefin-based substrate is about 120 nm to about 150 nm.

5. The separator according to claim 1, further comprising:
at least one of a heat-resistant coating layer and a binder adhesive layer on at least one surface of the polyolefin-based substrate.

6. An electrode assembly comprising:
the separator according to claim 1, and
a positive electrode and a negative electrode provided on respective opposite surfaces of the separator.

7. A separator manufacturing method comprising:
obtaining a polymer sheet by extruding, cooling, and molding a polyolefin resin raw material;
stretching the obtained polymer sheet in MD and TD; and
obtaining a polyolefin-based substrate by heat-setting the stretched polymer sheet,
wherein the heat-setting is performed at a temperature higher than the MD and TD stretching temperatures, and
the polyolefin-based substrate has a thickness of about 8 μm or less.

8. The separator manufacturing method according to claim 7, wherein the MD stretching is performed at a temperature of about 110° C. to about 115° C. at a stretching ratio of about 4 to about 10 times.

9. The separator manufacturing method according to claim 7, wherein the TD stretching is performed at a temperature of about 125° C. to about 135° C. at a stretching ratio of about 4 to about 10 times.

10. The separator manufacturing method according to claim 7, wherein the polyolefin-based substrate has a maximum pore size of about 150 nm or less.

11. An electrode assembly manufacturing method comprising:
interposing the separator manufactured according to claim 7 between a positive electrode and a negative electrode, and
hot-pressing the obtained laminate of the positive electrode/separator/negative electrode.

12. The electrode assembly manufacturing method according to claim 11, wherein the hot-pressing is performed at a temperature of about 55° C. to about 75° C.

13. The electrode assembly manufacturing method according to claim 11, wherein the hot-pressing is performed at a pressure of about 5 MPa to about 8 MPa.

14. An electrochemical device comprising:
the electrode assembly according to claim 6; and
a case accommodating the electrode assembly.

15. The separator manufacturing method according to claim 7, further comprising:
removing a diluent after the MD stretching and TD stretching steps.

16. The separator manufacturing method according to claim 15, wherein an amount of the diluent remaining in the polymer sheet formed after extracting the diluent is about 1 wt % or less based on the total weight of the polymer sheet.
